(19) United States
(12) Patent Application Publication
(10) Pub. No.: US 2024/0036697 A1
(43) Pub. Date: Feb. 1, 2024

(54) INFORMATION PROCESSING DEVICE AND INFORMATION PROCESSING PROGRAM

(71) Applicant: FUJIFILM CORPORATION, Minato-ku, Tokyo (JP)

(72) Inventors: Tatsuo FUKUSHIMA, Kanagawa (JP); Yuji ONOZAWA, Kanagawa (JP); Takafumi HARUTA, Kanagawa (JP); Yohei MAKINO, Kanagawa (JP)

(21) Appl. No.: 18/257,591

(22) PCT Filed: Jan. 24, 2022
(86) PCT No.: PCT/JP2022/002463

§ 371 Date: Jun. 15, 2023

(30) Foreign Application Priority Data
Jan. 26, 2021 (JP) 2021-010563

(51) Int. Cl. G06F 3/0481; G06F 3/04847; G06F 3/0488

(52) U.S. Cl. CPC G06F 3/0481; G06F 3/04847; G06F 3/0488

(57) ABSTRACT

An image formation device is provided with a CPU. The CPU performs control to execute a predetermined function upon execution of an operation by a user on an operation unit which is displayed at a display, and to change operability of the operation such that as an importance degree which is determined in accordance with an execution condition for the predetermined function becomes relatively high, a difficulty degree of the operation required for executing the predetermined function becomes high.

### TECHNICAL FIELD

The present invention relates to an information processing device and an information processing program.

### BACKGROUND ART

For example, Japanese Patent Application Laid-Open (JP-A) No. 2009-237820 describes a user interface control device that displays an operation screen at a display unit to receive a user's operation. The user interface control device includes a control unit that controls the operation screen based on a setting of the operation screen displayed on a user interface, and displays, on the user interface, information related to an erroneous operation on the operation screen when an input for changing the setting of the operation screen is received and the setting is changed based on the input.

### SUMMARY OF INVENTION

### Technical Problem

Meanwhile, there is a case where a slide start using a touch button is implemented on a touch panel type user interface (UI) screen. In the slide start, for example, a prescribed function is executed when the user performs an operation such as dragging or sliding on the operation unit.

In a case where the user performs an operation on the operation unit, it is desirable that the user can grasp an importance degree related to the function executed by the operation from the viewpoint of preventing an erroneous operation. However, in an operation method such as the slide start, it is not possible to grasp the importance degree related to the function executed by the operation.

An object of the present disclosure is to provide an information processing device and an information processing program capable of grasping an importance degree related to a function executed by an operation in a case where a user performs the operation on an operation unit.

### Solution to Problem

In order to achieve the above object, an information processing device according to a first aspect includes a processor, in which the processor configured to perform control to execute a predetermined function upon execution of an operation by a user on an operation unit displayed at a display, and change operability of the operation such that as an importance degree which is determined in accordance with an execution condition for the predetermined function becomes relatively high, a difficulty degree of the operation required for executing the predetermined function becomes high.

Furthermore, in an information processing device according to a second aspect, in the information processing device according to the first aspect, the operation is a moving operation performed on the operation unit by the user, and the processor is configured to perform control to move the operation unit so as to follow the moving operation in a movable region, which is a region in which the operation unit is movable when the moving operation is performed on the operation unit, including a start region which is a region in which the predetermined function is not executed and an execution region which is a region in which the predetermined function is executed, execute the predetermined function in a case in which the moving operation is finished after the operation unit is moved from the start region to the execution region by the moving operation, and change operability of the moving operation such that as the importance degree becomes relatively high, the difficulty degree of the moving operation required for executing the predetermined function becomes high.

Furthermore, in an information processing device according to a third aspect, in the information processing device according to the second aspect, changing operability of the moving operation includes changing a position of a boundary between the start region and the execution region, and the processor is configured to perform control to change the position of the boundary such that as the importance degree becomes relatively high, a length of the start region becomes longer and a length of the execution region becomes shorter.

Furthermore, in the information processing device according to a fourth aspect, in the information processing device according to the second aspect or the third aspect, changing operability of the moving operation includes changing a length of the movable region, and the processor is configured to perform control to change such that as the importance degree becomes relatively high, the length of the movable region becomes longer.

Furthermore, in an information processing device according to a fifth aspect, in the information processing device according to any one aspect of the second aspect to the fourth aspect, changing operability of the moving operation includes changing a number of inflection points at which a direction of the movable region is inflected, and the processor is configured perform control to change such that as the importance degree becomes relatively high, the number of inflection points of the movable region becomes larger.

Furthermore, in an information processing device according to a sixth aspect, in the information processing device according to any one aspect of the second aspect to the fifth aspect, changing operability of the moving operation includes changing a speed of the moving operation that enables following of the operation unit, and the processor is configured to perform control to change such that as the importance degree becomes relatively high, the speed of the moving operation that enables following of the operation unit becomes slower.

Furthermore, in the information processing device according to a seventh aspect, in the information processing device according to any one aspect of the second aspect to the sixth aspect, changing operability of the moving operation includes changing a number of times of the moving operation, and the processor is configured to perform control to change such that as the importance degree becomes relatively high, the number of times of the moving operation becomes larger.

Furthermore, in an information processing device according to an eighth aspect, in the information processing device according to any one aspect of the second aspect to the seventh aspect, changing operability of the moving operation includes changing from the moving operation on the operation unit to a contact operation on the operation unit not involving movement of the operation unit, and the processor is configured to perform control to change from the moving operation to the contact operation not involving movement of the operation unit in a case in which the importance degree is relatively low and is equal to or less than a threshold or in a case in which the importance degree is relatively low.

Furthermore, in order to achieve the above object, an information processing program according to a ninth aspect executes by a computer to perform control to: execute a predetermined function upon execution of an operation by a user on an operation unit which is displayed at a display; and change operability of the operation such that as an importance degree which is determined in accordance with an execution condition for the predetermined function becomes relatively high, a difficulty degree of the operation required for executing the predetermined function becomes high.

### Advantageous Effects of Invention

According to the first aspect and the ninth aspect, there is an effect that, in a case where the user performs an operation on the operation unit, it is possible to grasp the importance degree related to the function executed by the operation.

According to the second aspect, there is an effect that, in a case where the user performs a moving operation on the operation unit, it is possible to grasp the importance degree related to the function executed by the moving operation.

According to the third aspect, there is an effect that the difficulty degree of the moving operation can be made higher as the importance degree becomes relatively high as compared with a case where the position of the boundary is fixed.

According to the fourth aspect, there is an effect that the difficulty degree of the moving operation can be made higher as the importance degree becomes relatively high as compared with a case where the length of the movable region is fixed.

According to the fifth aspect, there is an effect that the difficulty degree of the moving operation can be made higher as the importance degree becomes relatively high as compared with a case where the number of inflection points of the movable region is fixed.

According to the sixth aspect, there is an effect that the difficulty degree of the moving operation can be made higher as the importance degree becomes relatively high as compared with a case where the speed of the moving operation that enables following of the operation unit is fixed.

According to the seventh aspect, there is an effect that the difficulty degree of the moving operation can be made higher as the importance degree becomes relatively high as compared with a case where the number of times of moving operation is fixed.

According to the eighth aspect, there is an effect that the difficulty degree of the operation can be made lower in a case where the importance degree is relatively low as compared with a case where the moving operation is performed even in a case where the importance degree is relatively low.

### BRIEF DESCRIPTION OF DRAWINGS

FIG. 1 is a block diagram illustrating an example of an electrical configuration of an image formation device according to an embodiment.

FIG. 2 is a block diagram illustrating an example of a functional configuration of the image formation device according to the embodiment.

FIG. 3 is a diagram illustrating an example of a screen displayed at a display unit by processing of a CPU.

FIG. 4 is a diagram illustrating an example of a movable region predetermined for an instruction unit.

FIG. 5 is a schematic diagram illustrating an example of a relationship between a user operation and a position of a slide mark with respect to the user operation in the instruction unit displayed at the display unit.

FIG. 6 is a diagram for explaining a moving operation according to the embodiment.

FIG. 7 is a diagram illustrating an example of an importance degree table according to the embodiment.

FIG. 8 is a flowchart illustrating an example of a flow of processing by an information processing program according to the embodiment.

FIG. 9 is a diagram illustrating an example of a relationship between an importance degree and a change in operability of a moving operation according to the embodiment.

FIG. 10 is a diagram illustrating another example of the relationship between the importance degree and the change in operability of the moving operation according to the embodiment.

FIG. 11 is a diagram illustrating still another example of the relationship between the importance degree and the change in operability of the moving operation according to the embodiment.

FIG. 12 is a diagram illustrating still another example of the relationship between the importance degree and the change in operability of the moving operation according to the embodiment.

FIG. 13 is a diagram illustrating still another example of the relationship between the importance degree and the change in operability of the moving operation according to the embodiment.

### DESCRIPTION OF EMBODIMENTS

Hereinafter, an example of a mode for carrying out the technology of the disclosure will be described in detail with reference to the drawings. The same reference numerals are assigned to components and processing in which the operation, action, and function perform the same effect throughout the drawings, and redundant description may be omitted, if appropriate. Each drawing is only schematically illustrated to the extent that the technology of the disclosure can be sufficiently understood. Therefore, the technology of the disclosure is not limited only to the illustrated example. In the present embodiment, description of configurations that are not directly related to the invention and well-known configurations may be omitted.

In the embodiment, an example of an information processing device that executes a predetermined function according to a user operation on an operation unit by a user's manual operation (hereinafter, referred to as a user operation) on the operation unit, such as a mark displayed at a display unit such as a display will be described.

In the disclosure, the “operation unit” is a concept including an image displayed at a display unit such as a display. The “moving operation” is a concept including an operation in which an instruction position by a user operation is changed while being sequentially moved. As examples of the moving operation, a user operation of moving while being in contact with a display unit such as a display, for example, and a user operation such as dragging and sliding in which a contact operation by the user is continued between a start point and a terminal point are exemplified. In the “start of a moving operation”, as the start of the instruction by the user, a user operation by starting contact to a display unit such as a display is exemplified. In the “finish of the moving operation”, as the termination of the instruction by the user, a user operation by contact release is exemplified. The “predetermined function” is a concept including a predetermined instruction (command) performed by a processor and information indicating the instruction. As the examples of the predetermined function, processing executed by the processor itself or another processor (for example, copying, printing, scanning, facsimile, and the like) is exemplified. The “execution of a function” is a concept including output of a predetermined instruction (command) performed by a processor and output of information indicating the instruction.

The operation according to the embodiment is not limited to the moving operation, and includes the contact operation not involving movement of the instruction position by the user operation.

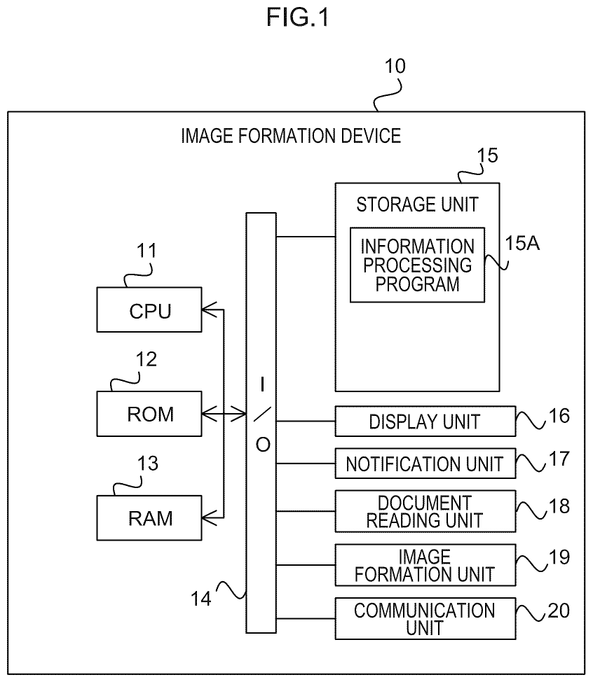

FIG. 1 is a block diagram illustrating an example of an electrical configuration of an image formation device 10 according to the present embodiment.

As illustrated in FIG. 1, the image formation device 10 according to the present embodiment includes a central processing unit (CPU) 11, a read only memory (ROM) 12, a random access memory (RAM) 13, an input/output interface (I/O) 14, a storage unit 15, a display unit 16, a notification unit 17, a document reading unit 18, an image formation unit 19, and a communication unit 20.

The image formation device 10 is an example of an information processing device. In addition to the image formation device 10, the information processing device according to the present embodiment is a general information processing device having a UI screen adopting a touch panel type, such as a smartphone, a tablet terminal, or a game device, for example.

Each unit of the CPU 11, the ROM 12, the RAM 13, and the I/O 14 is coupled via a bus. Each functional unit including the storage unit 15, the display unit 16, the notification unit 17, the document reading unit 18, the image formation unit 19, and the communication unit 20 is coupled to the I/O 14. These functional units can communicate with the CPU 11 via the I/O 14.

The CPU 11, the ROM 12, the RAM 13, and the I/O 14 configure a control unit. The control unit may be configured as a sub-control unit that controls a part of the operation of the image formation device 10, or may be configured as a part of a main control unit that controls the entire operation of the image formation device 10. For some or all of the blocks of the control unit, for example, an integrated circuit such as a large scale integration (LSI) or an integrated circuit (IC) chip set is used. An individual circuit may be used for each block, or a circuit in which some or all of the blocks are integrated may be used. The blocks may be provided integrally with each other, or some of the blocks may be provided separately. Some of each of the blocks may be provided separately. The integration of the control unit is not limited to the LSI, and a dedicated circuit or a general-purpose processor may be used.

As the storage unit 15, for example, a hard disk drive (HDD), a solid state drive (SSD), a flash memory, or the like is used. The storage unit 15 stores an information processing program 15A according to the present embodiment. The information processing program 15A may be stored in the ROM 12.

The information processing program 15A may be installed in the image formation device 10 in advance, for example. The information processing program 15A may be realized by being stored in a nonvolatile storage medium or distributed via a network and installed in the image formation device 10, if appropriate. As an example of the nonvolatile storage medium, a compact disc read only memory (CD-ROM), a magneto-optical disk, a hard disk drive (HDD), a digital versatile disc read only memory (DVD-ROM), a flash memory, a memory card, or the like is assumed.

As the display unit 16, for example, a liquid crystal display (LCD), an organic electro luminescence (EL) display, or the like is used. The display unit 16 integrally has a touch panel, and receives various input operations by the user via the touch panel. For example, the touch panel adopts a capacitive method. For the touch panel, a method other than the capacitive method may be adopted. The notification unit 17 outputs preset sound effects, vibration, and the like in accordance with various input operations.

The document reading unit 18 captures documents one by one placed on a sheet feeding table of an automatic document feeder (not illustrated) provided in an upper portion of the image formation device 10, and optically reads the captured documents to obtain image information. Alternatively, the document reading unit 18 optically reads a document placed on a document table such as a platen glass to obtain image information.

The image formation unit 19 forms an image based on image information obtained by reading by the document reading unit 18 or image information obtained from an external personal computer (PC) or the like coupled via a network on a recording medium such as paper. In the present embodiment, the electrophotographic method will be described as an example of a method for forming an image, but other methods such as an ink-jet method may be adopted.

In a case where the method of forming an image is the electrophotographic method, the image formation unit 19 includes a photosensitive drum, a charging unit, an exposure unit, a developing unit, a transfer unit, and a fixing unit. The charging unit applies a voltage to the photosensitive drum to charge a surface of the photosensitive drum. The exposure unit forms an electrostatic latent image on the photosensitive drum by exposing the photosensitive drum charged by the charging unit with light according to image information. The developing unit forms a toner image on the photosensitive drum by developing the electrostatic latent image formed on the photosensitive drum with toner. The transfer unit transfers the toner image formed on the photosensitive drum to a recording medium. The fixing unit fixes the toner image transferred to the recording medium by heating and pressing.

The communication unit 20 is coupled to a network such as the Internet, a local area network (LAN), or a wide area network (WAN), and can communicate with an external PC or the like via the network.

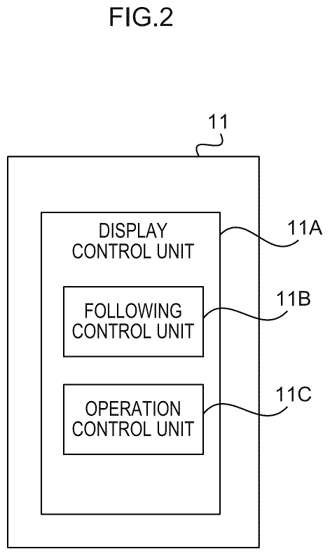

The CPU 11 of the image formation device 10 according to the present embodiment functions as each unit illustrated in FIG. 2 by writing and executing the information processing program 15A stored in the storage unit 15 in the RAM 13.

FIG. 2 is a block diagram illustrating an example of a functional configuration of the image formation device 10 according to the present embodiment.

As illustrated in FIG. 2, the CPU 11 of the image formation device 10 according to the present embodiment functions as a display control unit 11A. The display control unit 11A includes a following control unit 11B and an operation control unit 11C.

The display control unit 11A has a control function of controlling display of an image at the display unit 16 and a control function of controlling execution of a function and non-execution of a function according to a display position of an operation unit displayed as an image at the display unit 16.

The following control unit 11B performs control to display an image at the display unit 16 and control to display an operation unit displayed as an image so as to follow a moving operation by the user. That is, when the user performs a moving operation on the operation unit, the following control unit 11B displays the operation unit at a position at the display unit 16 followed by the moving operation while displaying the operation unit at the display unit 16.

When the moving operation on the operation unit displayed so as to follow the moving operation by the user is finished, the operation control unit 11C controls the execution of the function or the non-execution of the function according to the position of the operation unit. The non-execution of the function is control for maintaining a state (for example, an initial state) in which the execution of the function is not started by a moving operation that does not lead to the execution of the function. The control of execution of the function includes control of execution of a predetermined function.

Next, execution of the function by the CPU 11 of the image formation device 10 according to the present embodiment will be described. In the following description, execution of copying of a document will be described as an example of the execution of the function by the CPU 11. The execution of the function is not limited to the execution of copying of the document, and may be other processing executed in the image formation device 10.

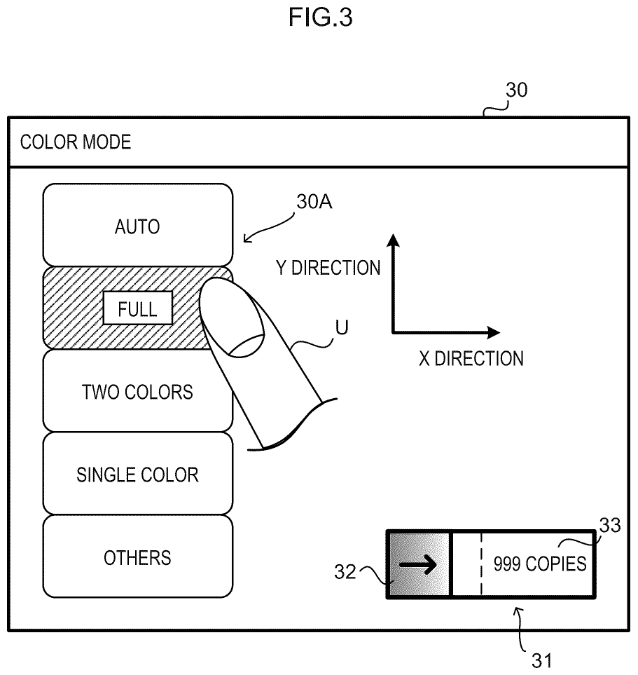

FIG. 3 is a diagram illustrating an example of a screen 30 displayed at the display unit 16 by the processing of the CPU 11.

FIG. 3 illustrates an example of a setting screen for performing a setting related to a color at the time of copying a document by exemplifying a copying condition in an image copying function among document related functions executed by the CPU 11. In the following description, a horizontal rightward direction and a vertical upward direction of the screen in a state where the user views the screen are referred to as an X direction and a Y direction, respectively.

In the example of the screen 30, a selection instruction button 30A for instructing a setting of the copying condition related to the color when the document is copied is displayed. The copying condition is a setting of a function of the image formation device 10 that can be set in the case of copying a copying target (for example, a document), and the function is set as a parameter. In the example illustrated in FIG. 3, selection instruction buttons for instructing the setting related to any color of “auto”, “full”, “two colors”, “single color”, and “others” are displayed. The “auto” button of the selection instruction button is a button for automatically detecting the color of the document and selecting and instructing copying with the color along the document. The “full” button is a button for selecting and instructing copying of the document in multiple colors included in the image formation device 10. The “two colors” button is a button for selecting and instructing copying in two predetermined colors. The “single color” button is a button for selecting and instructing copying with a predetermined single color. The “others” button is a button for selecting and instructing copying by setting other colors. Since the parameter of the copying condition is a known technology, the description thereof will be omitted.

FIG. 3 illustrates a screen in which the “full” button is highlighted when the “full” button is pressed by the user operation as a state in which the setting of the copying condition is instructed.

On the screen 30 illustrated in FIG. 3, when a copying condition is instructed, an image is displayed at the instruction unit 31 for instructing execution of copying. The instruction unit 31 includes a slide mark 32 indicating a movable image for instructing execution of copying, and a display region 33 for displaying a number of copies among the copying conditions. Although not illustrated here, the instruction unit 31 may include a message region for displaying a description of an operation method. In the message region, for example, a “slide and start” message indicating that copying is executed (that is, started) by moving (that is, sliding) the slide mark 32 is displayed. The slide mark 32 can also be displayed at a position moved in the X direction (and the opposite direction). The slide mark 32 is an example of the operation unit.

In the example of FIG. 3, when the slide mark 32 is brought into contact with a finger of a user U, the color changes, and a moving operation such as dragging or sliding becomes possible. In the display region 33, information depending on the function (for example, a copy function, a print function, a facsimile function, a scanner function, and the like) of the image formation device 10, such as a number of copies or a number of transmissions, is displayed.

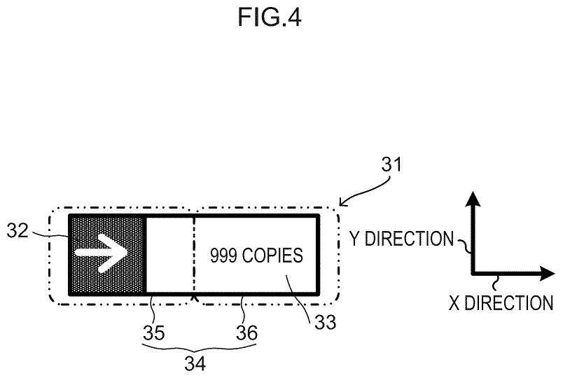

FIG. 4 is a diagram illustrating an example of the movable region 34 predetermined for the instruction unit 31.

The instruction unit 31 includes the movable region 34 which is a movable region of the slide mark 32. The movable region 34 is an example of a region for determining non-execution of copying and execution of copying according to the position of the slide mark 32 displayed movably. The movable region 34 includes a start region 35 and an execution region 36. The start region 35 is a region in which a predetermined function is not executed, and the execution region 36 is a region in which a predetermined function is executed. The predetermined function described herein is, for example, the above-described image copying function.

Specifically, the execution region 36 is a region for specifying that copying is executed when the slide mark 32 exists in the region when the moving operation is finished. The start region 35 is a region for specifying that copying is not executed (non-execution) when the slide mark 32 exists in the region when the moving operation is finished.

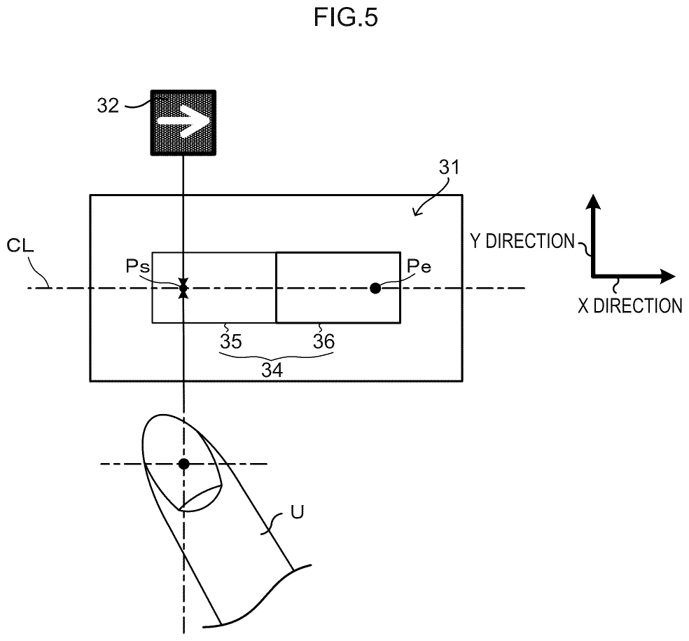

FIG. 5 is a schematic diagram illustrating an example of the relationship between the user operation and the position of the slide mark 32 with respect to the user operation in the instruction unit 31 displayed at the display unit 16.

The user U brings a finger of the user U into contact with the slide mark 32 displayed at the instruction unit 31 of the display unit 16 and instructs execution of copying while bringing the finger of the user U into contact with the slide mark 32. The slide mark 32 moves in a range in the X direction of the start region 35 and the execution region 36 on a line CL connecting the center positions of the start region 35 and the execution region 36 in the Y direction. More specifically, in the slide mark 32, an initial position Ps as a start point and an execution position Pe as an end point are determined in advance, and the slide mark 32 can be displayed between the initial position Ps and the execution position Pe.

That is, the movement of the finger of the user U is a two-dimensional movement in the X direction and the Y direction. That is, the finger of the user U may move in an oblique direction. The movement of the slide mark 32 moves only in the movable region 34 according to the moving operation by the user U, and the movement direction is limited to the X direction (or the opposite direction). The movement of the slide mark 32 is a one-dimensional movement. When a trajectory of the moving operation by the user U reaches an outside of the instruction unit 31, the slide mark 32 moves inside the movable region 34 by following the moving operation by the user U. That is, the position of the finger of the user U and the position of the slide mark 32 are in a projective relationship.

For example, when the center of the slide mark 32 in the X direction is positioned on the side of the start region 35, it is determined that the slide mark is positioned in the start region 35, and when the center of the slide mark 32 in the X direction is positioned on the side of the execution region 36, it is determined that the slide mark is positioned in the execution region 36. A boundary between the start region 35 and the execution region 36 can be set by the user, if appropriate.

In the examples of FIGS. 3 to 5, the instruction unit 31 is disposed sideways, but the disposition direction is not limited thereto. For example, the instruction unit 31 may be disposed vertically. In this case, the movement direction of the slide mark 32 is limited to the Y direction (or the opposite direction).

Returning to FIG. 2, as an example, the following control unit 11B detects the operation position (for example, coordinates) that is brought into contact by the finger of the user U on the screen 30 illustrated in FIG. 3 described above. A stylus pen or the like may be used instead of the finger of the user U. As described above, the moving operation described herein is, for example, an operation such as dragging or sliding. The trajectory of the moving operation is derived from a plurality of positions continuously detected by the moving operation. When the contact of the slide mark 32 by the finger of the user U is detected, the following control unit 11B derives the position of the slide mark 32 which is caused to follow the moving operation by the finger of the user U. Specifically, when the moving operation is performed on the slide mark 32 by the finger of the user U, the following control unit 11B moves the slide mark 32 so as to follow the moving operation in the movable region 34.

The operation control unit 11C controls a predetermined function (hereinafter, as an example, it is referred to as an “image copying function”) based on the operation position by the finger of the user U and the position of the slide mark 32. Specifically, the operation control unit 11C executes the image copying function when the moving operation is finished after the slide mark 32 is moved from the start region 35 to the execution region 36 by the moving operation by the finger of the user U.

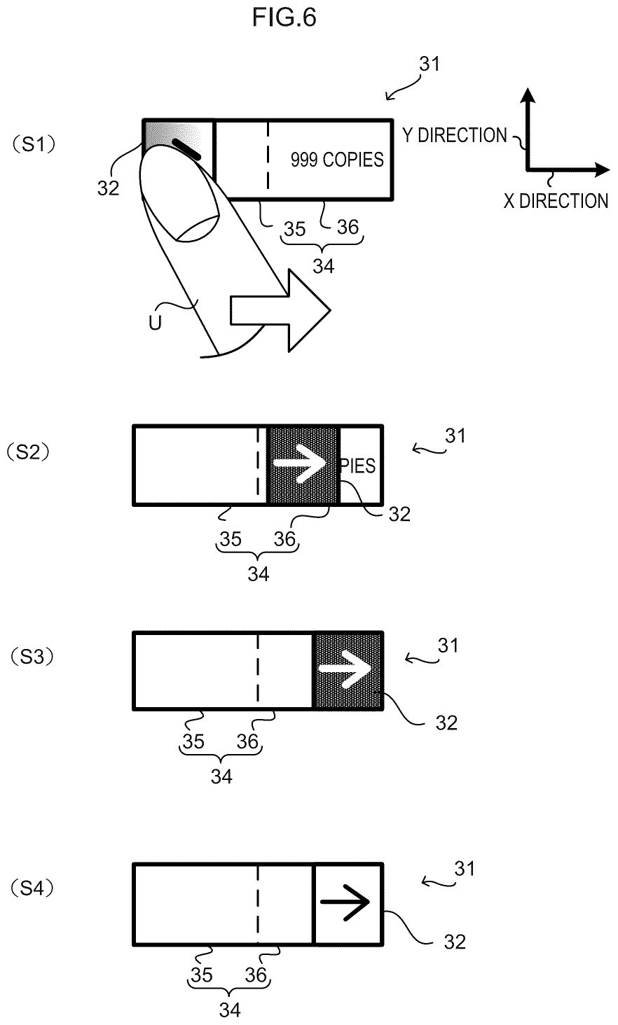

Next, the moving operation according to the present embodiment will be specifically described with reference to FIG. 6.

FIG. 6 is a diagram for explaining the moving operation according to the present embodiment.

In (S1), when the slide mark 32 is brought into contact by the finger of the user U, the CPU 11 detects the position thereof and changes the color of the slide mark 32 to a color representing an execution reservation of the function. Then, the slide mark 32 is moved in an arrow direction (X direction) by following the moving operation by the user U. In the initial state, the slide mark 32 is positioned at a start end (here, a left end) of the start region 35. When the finger of the user U is separated in a state where the slide mark 32 is separated from the start end and is positioned in the start region 35, it is determined that the moving operation is finished, and the slide mark 32 is returned to the start end, that is, attracted to the start end, and the image copying function is not executed.

In (S2), when the slide mark 32 is further moved in the X direction by following the moving operation by the user U, the CPU 11 detects that the slide mark 32 has exceeded the start region 35 and reached the execution region 36. At this time, text (for example, 999 copies) of a portion through which the slide mark 32 passes is hidden.

In (S3), when the slide mark 32 is further moved in the X direction by following the moving operation by the user U, the CPU 11 detects that the slide mark 32 has reached a terminal end (here, a right end) of the execution region 36. Here, when the finger of the user U is separated, it is determined that the moving operation is finished. When the finger of the user U is separated in a state where the slide mark 32 is positioned in the execution region 36 and has not reached the terminal end, it is determined that the moving operation is finished, and the slide mark 32 is moved to the terminal end, that is, attracted to the terminal end, as described above. However, it may be determined that the moving operation is finished only in a case where the finger of the user U is separated in a state where the slide mark 32 has reached the terminal end.

In (S4), the CPU 11 executes the image copying function, and changes the color of the slide mark 32 moved to the terminal end of the execution region 36 to a color representing the execution of the function. The execution of the image copying function is started at a time point when the slide mark 32 is moved to the terminal end of the execution region 36.

As illustrated in FIG. 6, in the instruction unit 31, in a case where the user U performs a moving operation on the slide mark 32, the slide mark 32 moves beyond the start region 35 into the execution region 36, and then the moving operation is finished, the image copying function is executed, as an example.

Meanwhile, in a case where the user performs an operation on the operation unit, it is desirable that the user can grasp an importance degree related to the function executed by the operation from the viewpoint of preventing an erroneous operation.

Therefore, the image formation device 10 according to the present embodiment includes the operation control unit 11C illustrated in FIG. 2 described above.

The operation control unit 11C performs control to change operability of the moving operation such that as the importance degree determined in accordance with the execution condition of the predetermined function (for example, the image copying function) becomes relatively high, a difficulty degree of the moving operation required for executing the predetermined function becomes high.

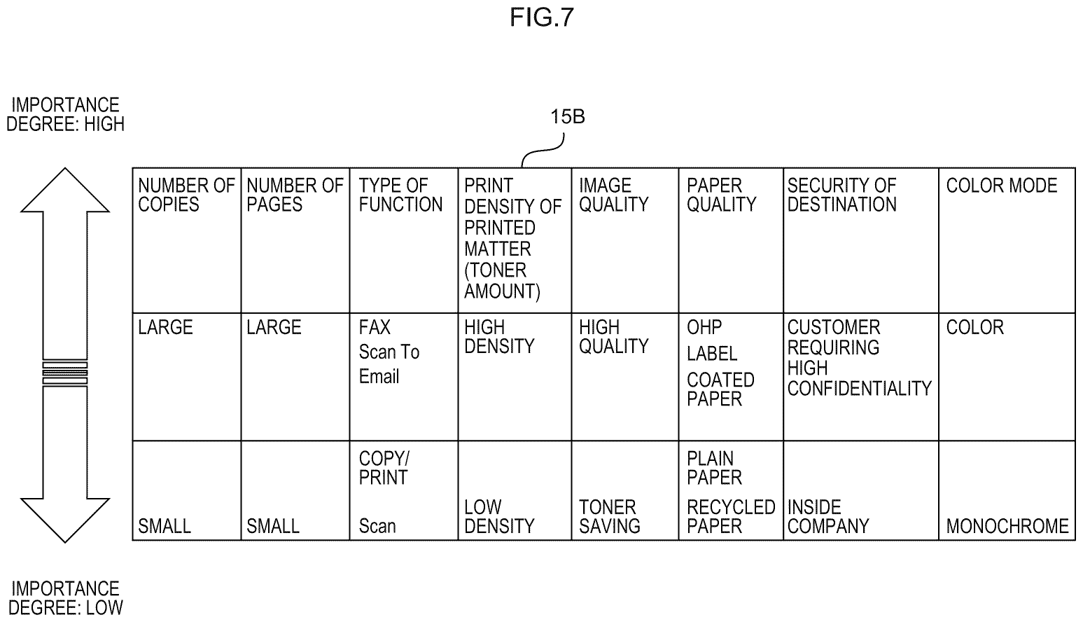

FIG. 7 is a diagram illustrating an example of an importance degree table 15B according to the present embodiment.

The importance degree table 15B illustrated in FIG. 7 is stored in the storage unit 15, for example. The “importance degree” described herein represents a level determined in accordance with an execution condition for the function. The execution condition represents various conditions specified when a function is executed, such as a type of function, or a setting value of a setting item for each function. As an example, as illustrated in FIG. 7, the execution conditions include a number of copies, a number of pages, a type of function, a print density of a printed matter (toner amount), an image quality, a paper quality, a security of a destination, a color mode, and the like.

As an example, as illustrated in FIG. 7, the importance degree is relatively high when the number of copies is large, and is relatively low when the number of copies is small. Whether the number of copies is large or small, for example, is determined by using a preset threshold. The importance degree is relatively high when the number of pages is large, and is relatively low when the number of pages is small. Whether the number of pages is large or small, for example, is determined by using a preset threshold.

The importance degree is relatively high in a case where the type of function is facsimile (FAX) or scan and send by e-mail (Scan To Email), and is relatively low in a case where the type of function is copy/print or scan (Scan). The importance degree is relatively high when the print density of the printed matter is high (the amount of toner is large), and is relatively low when the print density of the printed matter is low. Whether the print density of the printed matter is high or low is determined by using, for example, a preset threshold. The importance degree is relatively high in a case where the image quality is high, and is relatively low in a case where the image quality is low such as a toner saving mode. For example, a resolution represented in dot per inch (dpi) is used as the index of the image quality. Whether the image quality is high or low is determined by using, for example, a preset threshold.

The importance degree is relatively high when the paper quality is an overhead projector (OHP) sheet, label paper, or coated paper, and is relatively low when the paper quality is plain paper or recycled paper. The importance degree is relatively high when high security is required for the destination, and is relatively low when high security is not required for the destination. For example, the importance degree is high in a case where the destination is a customer (that is, a customer handling highly confidential cases) requiring high confidentiality, and the importance degree is low in a case where the destination is inside the company. The importance degree becomes relatively high when the color mode is color, and is relatively low when the color mode is monochrome.

The importance degree may be represented in two stages (binary values) of “high” or “low”, or may be represented in three or more stages. For example, in a case where the upper limit of the number of copies is set to 999 copies, the importance degree is set to “low” in a case where the number of copies is one or more and less than 500, and the importance degree is set to “high” in a case where the number of copies is 500 or more and 999 or less. Alternatively, the importance degree may be set to “low” in a case where the number of copies is one or more and less than 99, the importance degree may be set to “medium” in a case where the number of copies is 99 or more and less than 500, and the importance degree may be set to “high” in a case where the number of copies is 500 or more and 999 or less. Setting criteria, thresholds, combinations, and the like of the importance degree can be set by the user, if appropriate.

Regarding the “difficulty degree of the moving operation” described above, for example, it is assumed that the longer the time required until the function is executed by the moving operation, the higher the difficulty degree. For example, in a case where the change of operability of the moving operation is changing the position of the boundary between the start region 35 and the execution region 36, the CPU 11 performs, as the operation control unit 11C, control to change the position of the boundary such that the length of the start region 35 becomes longer and the length of the execution region 36 becomes shorter as the importance degree becomes relatively high. That is, by increasing the length of the start region 35 and decreasing the length of the execution region 36, the time required until the function is executed by the moving operation becomes longer, and the difficulty degree of the moving operation becomes high.

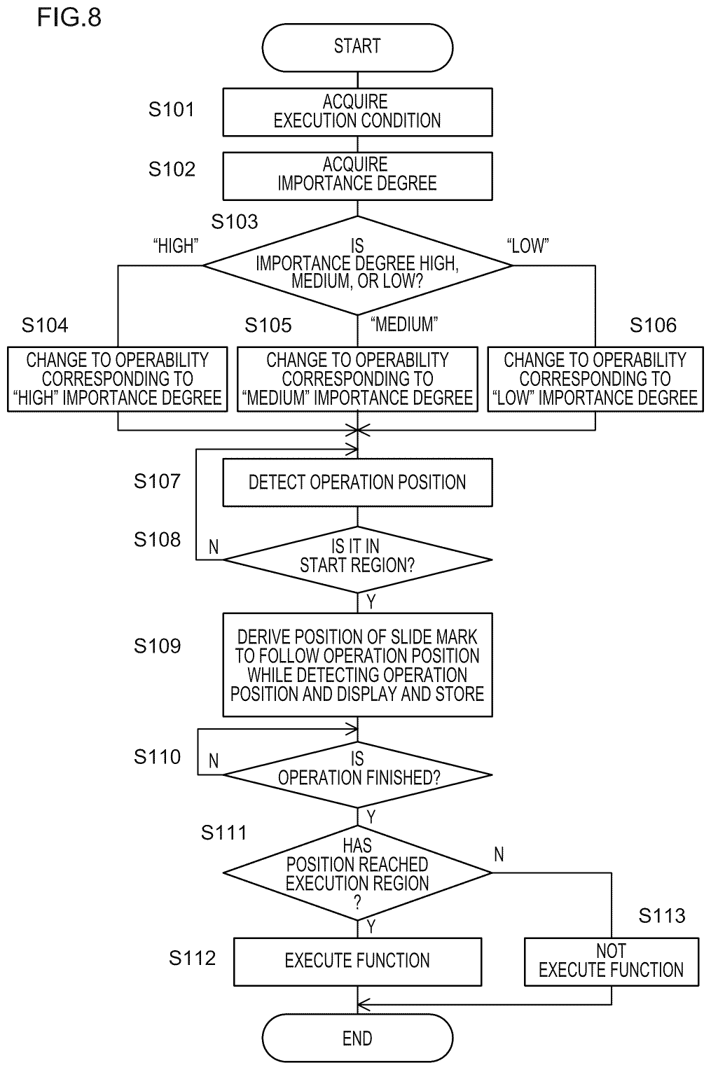

Next, the action of the image formation device 10 according to the present embodiment will be described with reference to FIG. 8.

FIG. 8 is a flowchart illustrating an example of a flow of processing by the information processing program 15A according to the present embodiment.

First, as an example, when execution of display of the screen 30 illustrated in FIG. 3 described above is instructed to the image formation device 10, the information processing program 15A is activated and executes the following steps.

In step S101 of FIG. 8, as an example, the CPU 11 acquires the execution condition (for example, the color mode) designated by the user U via the screen 30 illustrated in FIG. 3 described above. The acquired execution condition is not limited to the color mode, and may be, for example, the number of copies, the number of pages, image quality, or the like, as described above.

In step S102, the CPU 11 refers to the importance degree table 15B illustrated in FIG. 7 described above as an example based on the execution condition acquired in step S101, and acquires the importance degree determined in accordance with the execution condition.

In step S103, the CPU 11 determines whether the importance degree acquired in step S102 is “high”, “medium”, or “low”. In a case where it is determined that the importance degree is “high” (in the case of “high”), the processing proceeds to step S104. In a case where it is determined that the importance degree is “medium” (in the case of “medium”), the processing proceeds to step S105. In a case where the importance degree is “low” (in the case of “low”), the processing proceeds to step S106. In this example, the importance degree is set to three stages of “high”, “medium”, and “low”, but may be set to two stages of “high” and “low”, or may be set to four or more stages.

In step S104, the CPU 11 performs control to change operability of the moving operation such that the difficulty degree of the moving operation corresponds to the importance degree “high”.

In step S105, the CPU 11 performs control to change operability of the moving operation such that the difficulty degree of the moving operation corresponds to the importance degree “medium”.

In step S106, the CPU 11 performs control to change operability of the moving operation such that the difficulty degree of the moving operation corresponds to the importance degree “low”. A specific example of the relationship between the importance degree and the change of operability of the moving operation in steps S104 to S106 will be described later.

In step S107, as an example, the CPU 11 detects the operation position that is brought into contact by the finger of the user U on the screen 30 illustrated in FIG. 3 described above.

In step S108, the CPU 11 determines whether the operation position detected in step S107 is in the start region 35. When it is determined that the operation position is in the start region 35 (in the case of affirmative determination), the processing proceeds to step S109, and when it is determined that the operation position is not in the start region 35 (in the case of negative determination), the processing returns to step S107 and stands by.

In step S109, the CPU 11 derives the position of the slide mark 32 which is caused to follow the operation position while detecting the operation position by the finger of the user U, and displays and stores the derivation result.

In step S110, the CPU 11 determines whether the moving operation by the user U is finished. The determination of the finish of the moving operation is determined to be finished when the finger of the user U is separated from the slide mark 32 (including the release of the following relationship between the finger of the user U and the slide mark 32). In a case where it is determined that the moving operation is finished (in the case of affirmative determination), the processing proceeds to step S111, and in a case where it is determined that the moving operation is not finished (in the case of negative determination), the processing stands by in step S110.

In step S111, the CPU 11 determines whether the position of the slide mark 32 has reached the execution region 36 when the moving operation by the user U is finished in step S110. When it is determined that the position of the slide mark 32 reached the execution region 36 (in the case of affirmative determination), the processing proceeds to step S112, and when it is determined that the position of the slide mark 32 has not reached the execution region 36 (in the case of negative determination), the processing proceeds to step S113.

In step S112, the CPU 11 executes the image copying function as an example of the predetermined function, and terminates a series of processing by the information processing program 15A.

In step S113, the CPU 11 terminates the series of processing by the information processing program 15A without executing the image copying function as an example of the predetermined function.

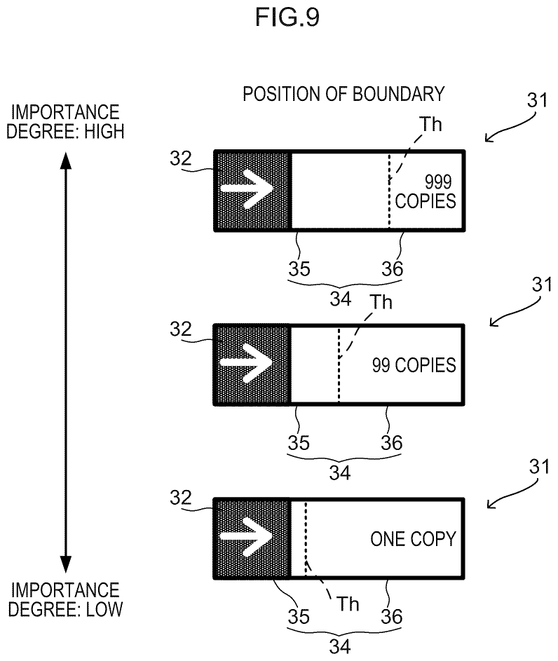

Next, the relationship between the importance degree and the change of operability of the moving operation will be specifically described with reference to FIGS. 9 to 13.

FIG. 9 is a diagram illustrating an example of the relationship between the importance degree and the change of operability of the moving operation according to the present embodiment.

As illustrated in FIG. 9, the change of operability of the moving operation includes changing the position of a boundary Th between the start region 35 and the execution region 36. In the case of the example of FIG. 9, the CPU 11 performs control to change the position of the boundary Th such that the length of the start region 35 becomes longer and the length of the execution region 36 becomes shorter as the importance degree becomes relatively high (for example, the number of copies is large). That is, as described above, by increasing the length of the start region 35 and decreasing the length of the execution region 36, the time required until the function is executed by the moving operation becomes longer, and the difficulty degree of the moving operation becomes high.

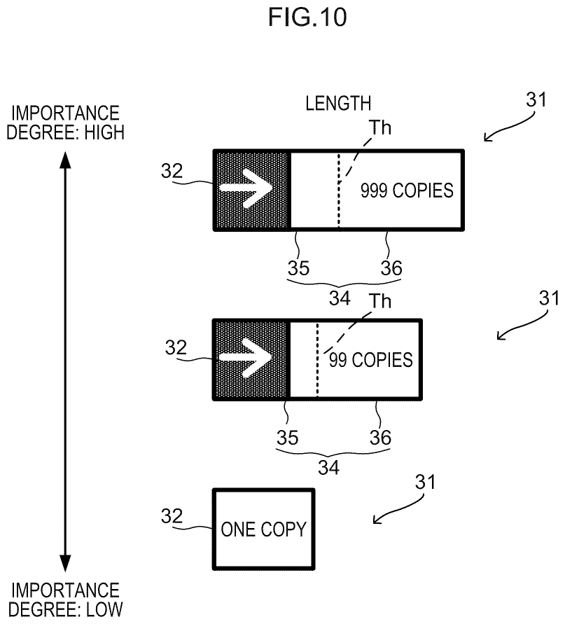

FIG. 10 is a diagram illustrating another example of the relationship between the importance degree and the change of operability of the moving operation according to the present embodiment.

As illustrated in FIG. 10, the change of operability of the moving operation includes changing the length of the movable region 34. In the case of the example of FIG. 10, the CPU 11 performs control to change such that as the importance degree becomes relatively high, the length of the movable region 34 becomes longer (for example, the number of copies is large). That is, by increasing the length of the movable region 34, the time required until the function is executed by the moving operation becomes longer, and the difficulty degree of the moving operation becomes high.

Here, the change of operability of the moving operation may include changing from the moving operation on the slide mark 32 to the contact operation on the slide mark 32 not involving movement of the slide mark 32. In the case of the example of FIG. 10, in a case where the importance degree is relatively low (for example, the number of copies is small) and equal to or less than the threshold (for example, ten copies or less), the CPU 11 performs control to change from the moving operation to the contact operation not involving movement of the slide mark 32. In the example of FIG. 10, in a case where the number of copies is “one copy”, the slide mark 32 is fixed and it is changed to the contact operation with respect to the slide mark 32. In this case, an arrow of the slide mark 32 is not displayed. Then, after the finger of the user U comes into contact with the slide mark 32, when the finger of the user U is separated, the function is executed. In a case where the importance degree is in two stages of “high” and “low”, the determination of the threshold need not be performed. In this case, in a case where the importance degree is relatively low (for example, the number of copies is small), the CPU 11 performs control to change from the moving operation to the contact operation not involving movement of the slide mark 32.

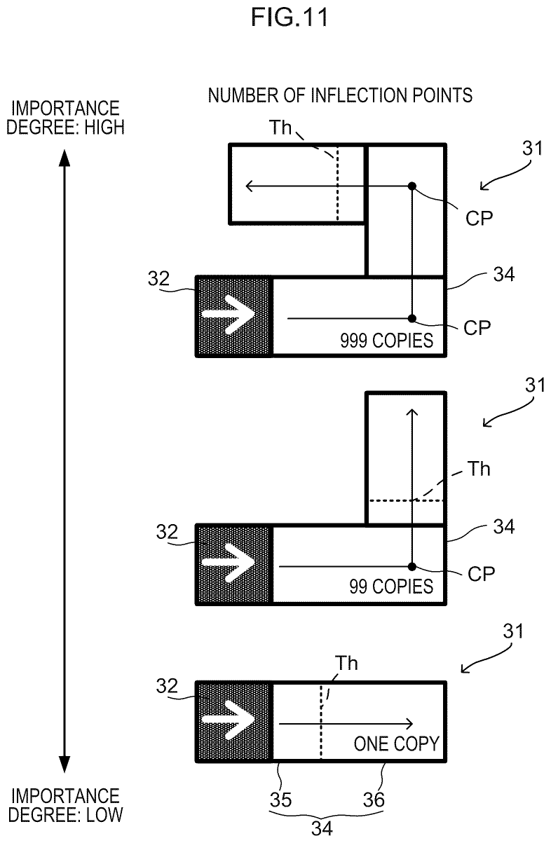

FIG. 11 is a diagram illustrating still another example of the relationship between the importance degree and the change of operability of the moving operation according to the present embodiment.

The “difficulty degree of the moving operation” may be set such that the more complicated the shape of the movable region 34, the higher the difficulty degree, for example. For example, it is assumed that the difficulty degree of the moving operation is high when the shape of the movable region 34 is a pattern such as an L shape or the like (a pattern including one or more inflection points) than when it is linear.

Specifically, as illustrated in FIG. 11, the change of operability of the moving operation includes changing the number of inflection points CP at which the direction of the movable region 34 is inflected. In the case of the example of FIG. 11, the CPU 11 performs control to change such that as the importance degree becomes relatively high, the number of inflection points CP in the movable region 34 becomes larger (for example, the number of copies is large). That is, by increasing the number of inflection points CP in the movable region 34, the shape of the movable region 34 becomes complicated, so that the difficulty degree of the moving operation becomes high.

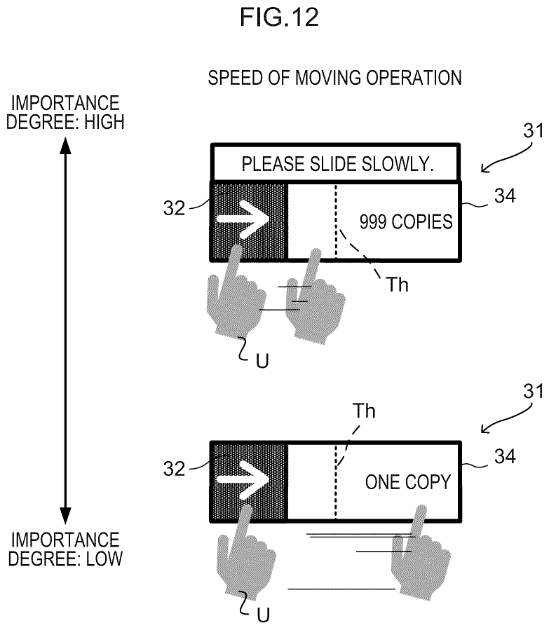

FIG. 12 is a diagram illustrating still another example of the relationship between the importance degree and the change of operability of the moving operation according to the present embodiment.

As illustrated in FIG. 12, the change of operability of the moving operation includes changing the speed of the moving operation by the user U, that enables following of the slide mark 32. In the case of the example of FIG. 12, the CPU 11 performs control to change such that as the importance degree becomes relatively high, the speed of the moving operation by the user U, that enables the following of the slide mark 32, becomes slower (for example, the number of copies is large). Specifically, in a case where the importance degree is “high”, only a moving operation in which a moving speed of the finger of the user U is relatively slow is received, and a moving operation in which a moving speed of the finger of the user U is relatively fast is not received, and error notification is performed. In a case where the importance degree is “low”, a moving operation in which the moving speed of the finger of the user U is relatively fast is received. That is, by slowing down the speed of the moving operation by the user U, that enables the following of the slide mark 32, the time required until the function is executed by the moving operation becomes longer, and the difficulty degree of the moving operation becomes high.

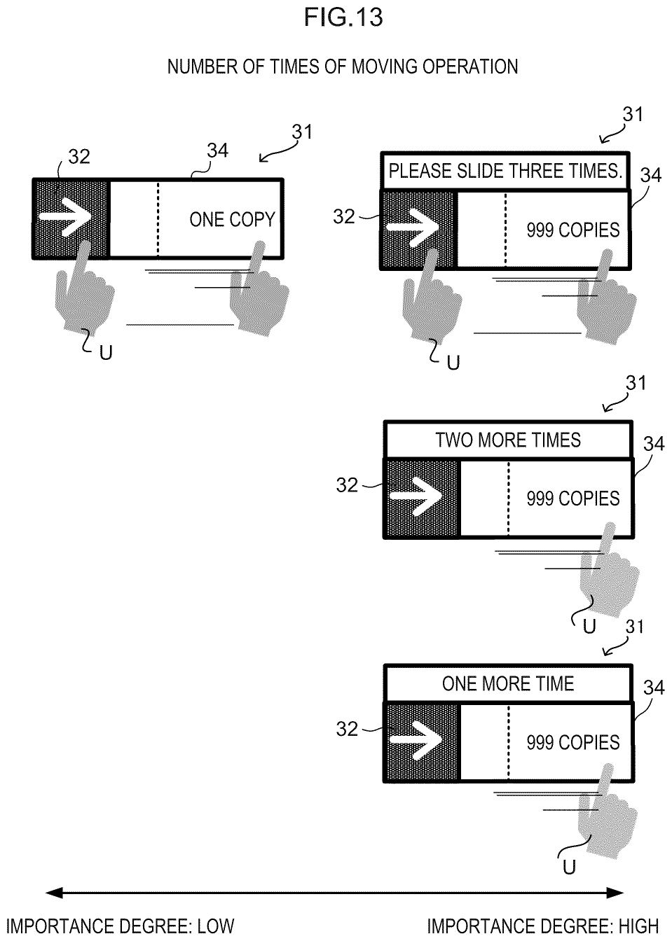

FIG. 13 is a diagram illustrating still another example of the relationship between the importance degree and the change of operability of the moving operation according to the present embodiment.

As illustrated in FIG. 13, the change of operability of the moving operation includes changing the number of times of the moving operation by the user U. In the case of the example of FIG. 13, the CPU 11 performs control to change such that as the importance degree becomes relatively high, the number of times of the moving operation becomes larger (for example, the number of copies is large). That is, by increasing the number of times of moving operation, the time required until the function is executed by the moving operation becomes longer, and the difficulty degree of the moving operation becomes high.

As described above, according to the present embodiment, in a case where the user performs the moving operation on the operation unit, operability of the moving operation is changed such that as the importance degree determined in accordance with the execution condition for the function executed by the moving operation becomes relatively high, the difficulty degree of the moving operation becomes high. Therefore, the user can grasp that the function to be executed is important.

In the above embodiment, a mode in which the operation unit moves according to the moving operation by the user has been described. The embodiment may be a mode in which the operation unit does not move, that is, the operation unit is fixed. In this case, the operation unit is, for example, a touch type button fixed at a prescribed position at the display unit 16. When a contact operation is performed on the operation unit as an example of the operation by the user, the CPU 11 executes a predetermined function (for example, the image copying function). The CPU 11 performs control to change operability of the contact operation such that as the importance degree determined in accordance with the execution condition for the predetermined function becomes relatively high, the difficulty degree of the contact operation required for executing the predetermined function becomes high.

For example, the change of operability of the contact operation includes changing the number of times of the contact operation by the user. Specifically, the CPU 11 performs control to change such that as the importance degree becomes relatively high, the number of times of the contact operation becomes larger (for example, the number of copies is large). That is, by increasing the number of times of the contact operation, the time required until the function is executed by the contact operation becomes longer, and the difficulty degree of the contact operation becomes high. Alternatively, the change of operability of the contact operation includes changing the time from the start of the contact to the termination of the contact by the user. Specifically, the CPU 11 performs control such that as the importance degree becomes relatively high (for example, the number of copies is large), the time from the start of the contact to the termination of the contact becomes longer. When the finger of the user is separated in a time shorter than a prescribed time from the start of the contact by the user even though the importance degree is relatively high, the function is not executed. That is, by increasing the time of the contact operation, the time required until the function is executed by the contact operation becomes longer, and the difficulty degree of the contact operation also becomes high. In the above embodiment, the processor refers to a processor in a broad sense, and includes a general-purpose processor (for example, CPU: Central Processing Unit, and the like) or a dedicated processor (for example, GPU: Graphics Processing Unit, ASIC: Application Specific Integrated Circuit, FPGA: Field Programmable Gate Array, Programmable Logic Device, and the like).

The operation of the processor in the above embodiment may be performed not only by one processor but also by cooperation of a plurality of processors existing at physically separated positions. An order of each operation of the processor is not limited to the order described in the above embodiment, and may be changed, if appropriate.

The image formation device has been described above as an example of the information processing device according to the embodiment. The embodiment may be in the form of a program for causing a computer to execute the function of each unit included in the image formation device. The embodiment may be in the form of a non-transitory computer-readable storage medium storing these programs.

In addition, the configuration of the image formation device described in the above embodiment is an example, and may be changed according to the situation without departing from the gist.

The flow of processing of the program described in the above embodiment is also an example, and unnecessary steps may be deleted, new steps may be added, or the processing order may be changed within a scope not departing from the gist.

In the above-described embodiment, a case where the processing according to the embodiment is realized by a software configuration using a computer by executing a program has been described, but the invention is not limited thereto. The embodiment may be realized by, for example, a hardware configuration or a combination of a hardware configuration and a software configuration.

The disclosure of Japanese Patent Application No. 2021-010563 filed on Jan. 26, 2021 is incorporated herein by reference in their entirety. All documents, patent applications, and technical standards described in this specification are incorporated herein by reference to the same extent as if each document, patent application, and technical standard were specifically and individually indicated to be incorporated by reference.

1. An information processing device comprising:
a processor configured to perform control to:
execute a predetermined function upon execution of an operation by a user on an operation unit displayed at a display, and
change operability of the operation such that as an importance degree which is determined in accordance with an execution condition for the predetermined function becomes relatively high, a difficulty degree of the operation required for executing the predetermined function becomes high.

2. The information processing device according to claim 1, wherein:
the operation is a moving operation performed on the operation unit by the user, and
the processor is configured to perform control to:
move the operation unit so as to follow the moving operation in a movable region, which is a region in which the operation unit is movable when the moving operation is performed on the operation unit, including a start region which is a region in which the predetermined function is not executed and an execution region which is a region in which the predetermined function is executed,
execute the predetermined function in a case in which the moving operation is finished after the operation unit is moved from the start region to the execution region by the moving operation, and
change operability of the moving operation such that as the importance degree becomes relatively high, the difficulty degree of the moving operation required for executing the predetermined function becomes high.

3. The information processing device according to claim 2, wherein:
changing operability of the moving operation includes changing a position of a boundary between the start region and the execution region, and
the processor is configured to perform control to change the position of the boundary such that as the importance degree becomes relatively high, a length of the start region becomes longer and a length of the execution region becomes shorter.

4. The information processing device according to claim 2, wherein:
changing operability of the moving operation includes changing a length of the movable region, and
the processor is configured to perform control to change such that as the importance degree becomes relatively high, the length of the movable region becomes longer.

5. The information processing device according to claim 2, wherein:
changing operability of the moving operation includes changing a number of inflection points at which a direction of the movable region is inflected, and
the processor is configured to perform control to change such that as the importance degree becomes relatively high, the number of inflection points of the movable region becomes larger.

6. The information processing device according to claim 2, wherein:
changing operability of the moving operation includes changing a speed of the moving operation that enables following of the operation unit, and
the processor is configured to perform control to change such that as the importance degree becomes relatively high, the speed of the moving operation that enables following of the operation unit becomes slower.

7. The information processing device according to claim 2, wherein:
changing operability of the moving operation includes changing a number of times of the moving operation, and
the processor is configured to perform control to change such that as the importance degree becomes relatively high, the number of times of the moving operation becomes larger.

8. The information processing device according to claim 2, wherein:
changing operability of the moving operation includes changing from the moving operation on the operation unit to a contact operation on the operation unit not involving movement of the operation unit, and
the processor is configured to perform control to change from the moving operation to the contact operation not involving movement of the operation unit in a case in which the importance degree is relatively low and is equal to or less than a threshold or in a case in which the importance degree is relatively low.

9. A non-transitory computer-readable storage medium storing an information processing program executable by a computer to perform control to:
execute a predetermined function upon execution of an operation by a user on an operation unit which is displayed at a display; and
change operability of the operation such that as an importance degree which is determined in accordance with an execution condition for the predetermined function becomes relatively high, a difficulty degree of the operation required for executing the predetermined function becomes high.
